(19) United States
(12) Patent Application Publication
(10) Pub. No.: US 2005/0189304 A1
(43) Pub. Date: Sep. 1, 2005

(54) Decanter mooring systems and methods

(75) Inventor: James E. Thompson, The Woodlands, TX (US)

Correspondence Address: Jeffrey L. Wendt, 34 Driftoak Circle, The Woodlands, TX, 77381, US

(73) Assignee: Ashbrook Corporation, Houston, TX (US)

(21) Appl. No.: 10/788,846

(22) Filed: Feb. 26, 2004

(51) Int. Cl. B01D 21/24

(52) U.S. Cl. 210/776; 210/122; 210/242.1

(57) ABSTRACT

Decanter mooring systems and methods are provided. Decanter mooring systems of the invention include a decanter having a discharge orifice, the decanter disposed within a reactor containing a liquid and adapted to move vertically in relation to the surface of the liquid, a discharge conduit connected to the discharge orifice so as to be moveable in relationship with the decanter, and a stabilizing arm having a first end moveably connected to the reactor in a manner to limit the lateral movement of the decanter in the reactor.

### BACKGROUND INFORMATION

1. Technical Field

The present invention relates in general to waste liquid treatment and more particularly to a decanter mooing system, where the decanter is moored to a basin or other waste liquid container.

2. Background Art

In a sequencing batch reactor process of wastewater treatment a reactor is operated in a batch treatment mode involving a fill phase, aerate or react phase, a settle phase and a decant phase. During the aerate phase the wastewater influent is mixed and aerated. In the settle phase the suspended solids are allowed to settle typically forming a scum surface, a layer of supernatant, and a sludge blanket. In the decant phase the relatively clear supernatant is removed without drawing solids from the scum layer or sludge blanket. When in a non-decant phase it is necessary to prevent accumulation of suspended solids in the decanter that will contaminate the supernatant that is drawn in to the weir in the decant phase.

The quality of the withdrawn supernatant is affected by the design of the decanter. If during the decant phase the decanter draws in floating solids from the scum layer or material from the sludge blanket the quality of the discharged supernatant will be unacceptable as a discharge effluent. Further, if suspended solids enter the weir of the decanter during the non-decant phases of the process the solids will be discharged with the supernatant during the decant phase adversely affecting the quality of the discharged supernatant.

Prior art decanters are generally classified as fixed decanters or floating decanters. In the fixed type decanter the discharge conduit is fixedly connected to the reactor. Both the decanter and discharge pipe are positioned in a fixed position requiring precise control of the liquid levels within the reactor to withdraw supernatant form the reactor. The fixed type decanters require relatively expensive installation procedures to fixedly connect as the elements in a location that can not be readily changed for various processes. Additionally, these fixed type processes require significant time and expense to maintain and/or replace a discharge pipe.

Non-fixed type decanters move vertically with the change in the fluid level in the reactor during the SBR process. These devices typically include a discharge conduit that can move within a limited range vertically in conjunction with the change in the fluid level. Prior art discharge conduits have included a pair of articulation mechanisms to allow for this vertical movement.

It is commonly desired to maintain non-fixed type decanters within a position so as to be proximate a catwalk or pier for easy access when needed. It is also often desired to limit the lateral movement of the decanter in turbulent conditions such as in high wind conditions. The prior art decanter mooring systems typically include guidepost connected between the bottom of the reactor and the decanter to maintain the decanter in a affixed position within the reactor. The decanters are connected to the guideposts so as to be able to move vertically along the length of the guideposts. These prior art devices have several drawbacks. Drawbacks include the required installation and maintenance of the guideposts, in particular having the installation on the bottom of the reactor where the solids settle. Another drawback is the decanter sticking or becoming misaligned within the guideposts allowing solids to enter the decanter and contaminate the supernatant discharged.

It is therefore desired to provide a decanter mooring system that allows a decanter of any design to move within a vertical plane while maintaining the decanter in a substantially stationary lateral position within a reactor. It is a further desire to provide a decanter mooring system that is relatively simple to install within a reactor, and that may be readily utilized in new installations and retrofits.

### SUMMARY OF THE INVENTION

In accordance with the present invention, decanter mooring systems are presented which reduce or overcome many of the problems known in the art.

A first aspect of the invention is a decanter mooring system, the system including a decanter having a discharge orifice, the decanter being disposed within a reactor containing a liquid and adapted to move vertically in relation to the surface of the liquid, a discharge conduit connected to the discharge orifice in a manner so as to be moveable in relation to the decanter, and a stabilizing arm having a first end moveably connected to the reactor in a manner to limit the lateral movement of the decanter in the reactor and a second end connected to the reactor. The decanter mooring systems of the invention are applicable to any known floating decanter, including, but not limited to the semi-submersible floating decanters described in assignee's co-pending patent application Ser. No. ______, incorporated herein by reference. Decanters which may be moored using the systems of the invention typically are of the non-fixed type and are allowed to move in relation to the changes in the liquid level in the reactor. Decanters that may be moored using the systems of the invention may include a weir that is fixedly connected to the float or moveably connected in relation to the float, and may include an adjustment mechanism to move the decanter between a non-decant position and a decant position.

The discharge conduit may be constructed of substantially rigid member having at least one hinged section adapted for allowing the discharge pipe to move relative to the attached decanter. In a preferred embodiment the discharge conduit includes two hinged sections, a first hinged section positioned proximate a sidewall of the reactor and a second hinged section positioned proximate the decanter. The discharge conduit may be constructed of a flexible member.

Decanter mooring systems of the invention include at least one stabilizing arm connected between either the discharge conduit or the decanter. Decanter mooring systems of the invention may include more than one stabilizing arm. The stabilizing arm(s) function to maintain the decanter in a desired location laterally within the reactor and allow vertical movement of the decanter. The first end of the stabilizing arm is moveably connected to a sidewall of the reactor in a manner to allow the stabilizing arm to move vertically within the reactor. With a substantially rigid discharge conduit the second end of the stabilizing arm may be connected to either the discharge conduit or the decanter. The second end may be fixedly or moveably connected to the discharge conduit or the decanter. In embodiments having a flexible discharge conduit the second end of the stabilizing arm is connected to the decanter. It is desired that the stabilizing arm allow the decanter to maintain a substantially parallel orientation in relation to the surface of the liquid throughout the vertical range of motion of the decanter.

Further aspects and advantages of the invention will become apparent by reviewing the description of embodiments that follows.

### BRIEF DESCRIPTION OF THE DRAWING

For a more complete understanding of the present invention, and the advantages thereof, reference is now made to the following descriptions taken in conjunction with the accompanying drawings, in which:

FIG. 1 is a partial cross-sectional, top view of an embodiment of a decanter mooring system of the invention; and

FIG. 2 is a partial cross-sectional, side view of the embodiment of FIG. 1.

### Detailed Description

Referring now the drawing figures, wherein depicted elements are not necessarily illustrated to scale and wherein like or similar elements are designated by the same references numeral through the several views.

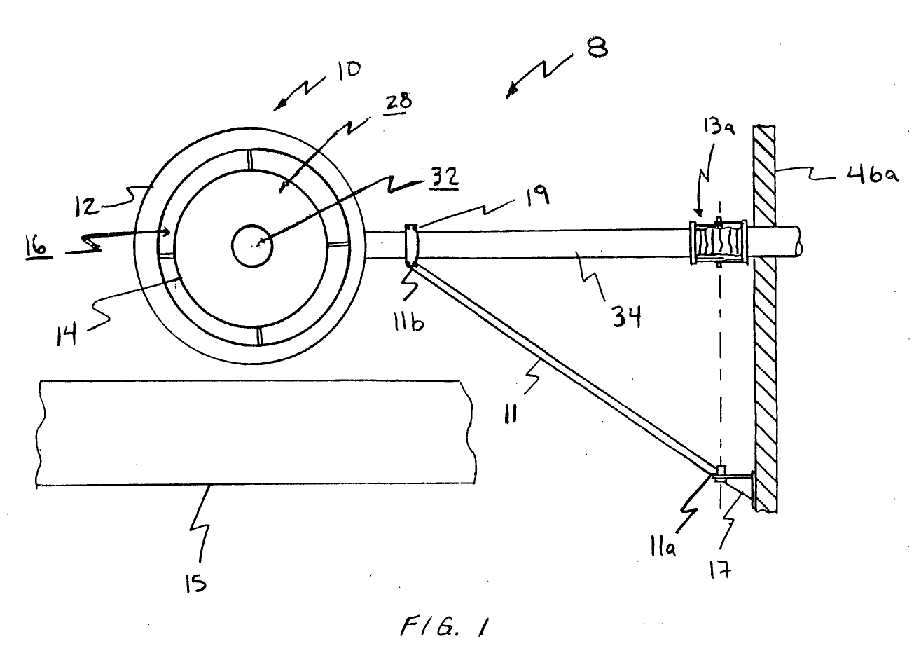

FIG. 1 is partial cross-sectional, top view of an embodiment of a decanter mooring system of the invention, generally designated by the numeral 8. Decanter mooring system 8 includes a decanter 10, a discharge conduit 34, and at least one stabilizing arm 11.

Decanter 10 includes a float 12 and a weir 14. Float 12 may be a torus shaped member or any other shaped member having a central passageway 16, in this case an annulus. Weir 14 includes an inlet opening 28 and a discharge orifice 32. Weir 14 is positioned within center annulus 16. Weir 14 may be fixedly or moveably positioned within center annulus 16. Various types of decanters 10 may be moored using the mooring system of the present invention, the only requirement being that the decanter is a floating decanter. One example of a floating decanter is that described in assignee's co-pending application Ser. No. ______, filed ______ (reference number 100-P001US) incorporated by reference herein.

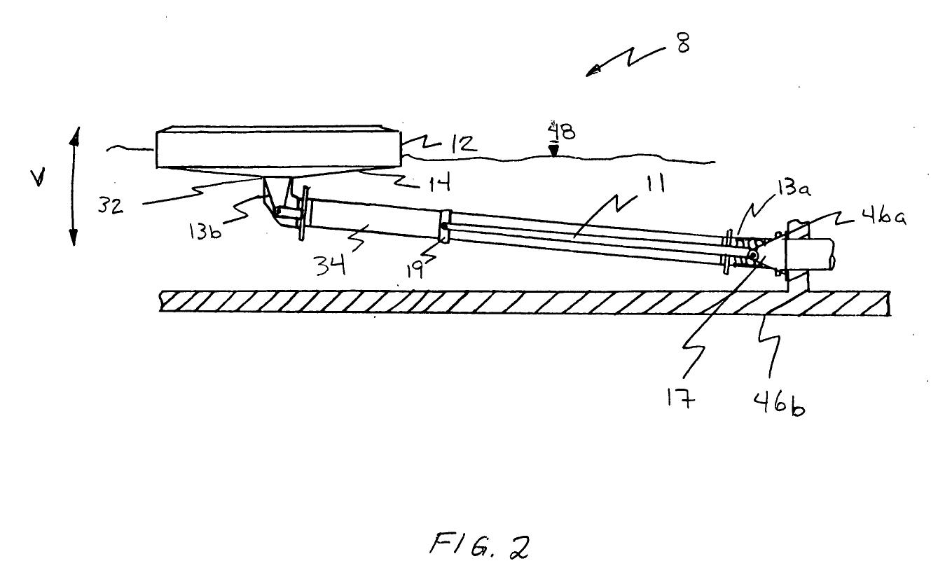

Discharge conduit 34 is connected in fluid communication with discharge orifice 32 of weir 14 and extends through a sidewall 46a of reactor 46 so as to discharge the supernatant to a desired location. In a preferred embodiment as illustrated in FIG. 1, discharge conduit 34 is a substantially rigid, hollow cylindrical member having at least one hinged section 13. In a preferred embodiment discharge conduit 34 includes a first hinged section 13a positioned proximate sidewall 46a and a second hinged section 13b (FIG. 2) positioned proximate the connection at discharge orifice 32. Hinge sections 13 permit discharge conduit and thus decanter 10 to move in the vertical direction with the changing fluid level in the reactor.

Decanter mooring system 8 includes a stabilizing arm 11 for maintaining decanter 10 in a substantially set position laterally within reactor 46. For example, it is often desired to maintain decanter 10 in a position proximate a catwalk 15. Additionally, stabilizing arm 11 stabilized decanter 10 and discharge conduit 34 in turbulent conditions, such as when high winds may laterally move decanter 10, possibly damaging decanter 10 and/or discharge conduit 34.

Stabilizing arm 11 is an elongated member moveably connected at a first end 11 a to reactor sidewall 46a by a connector 17 that allows rotation of stabilizing arm 11 in a substantially vertical plane. It is desired that rotational connector 33 be substantially aligned with hinged section 13a of discharge conduit 34. A second end 11b of stabilizing arm 11 is connected to discharge conduit 34 by a connector 19 shown as a clamp. Second end 11b may be either fixedly or moveably connected to discharge conduit 34. It may be desired to connect second end 11b of stabilizing arm 11 to decanter 10. If connected to decanter 10, the stabilizing arm may be connected either to the float, the weir, or both.

FIG. 2 is a partial cross-sectional, side view of the decanter mooring system embodiment 8 of FIG. 1. Hinged section 13b is demonstrated in this view of decanter mooring system 8. Hinged section 13b facilitates decanter 10 remaining in a substantially parallel plane with liquid surface 48 while decanter 10 and discharge conduit 34 move vertically as illustrated by the double headed arrow designated V.

The inventive decanter mooring systems are particularly useful in methods of decanting supernatant from a liquor in wastewater treatment facilities, and these methods of using the inventive decanter mooring systems are also considered within the invention. Depending on the nature of the wastewater being treated, weather conditions expected over the normal life of a given decanter, the access available to human operators to the decanter, reliability of electrical equipment such as switches and the like, and similar criteria, the decanter mooring systems of the present invention and methods of their use may entail great variation in the various components. For example, the number, length, strength, corrosion resistance and other chemical and physical properties of the stabilizer arm and discharge pipe are dependent upon these criteria, as are the hinges and other components.

From the foregoing detailed description of specific embodiments of the invention, it should be apparent that novel and patentable decanter mooring systems and methods of using same have been described. Although specific embodiments of the invention have been described herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the described embodiments without departing from the scope of the appended claims. For example, various materials of construction may be utilized, and variations in the decanter type (shape, buoyancy, submersible, semi-submersible, and the like) are considered within the invention.

1. A decanter mooring system comprising:
a) a decanter having a discharge orifice, said decanter disposed within a reactor containing a liquid, said decanter adapted to move vertically in relation to the surface of said liquid;
b) a discharge conduit connected to said discharge orifice in moveable relationship with said decanter; and
c) a stabilizing arm having a first end moveably connected to said reactor and a second end connected to a component selected from the group consisting of said decanter, said discharge conduit, and both said decanter and said discharge conduit, in a manner to limit the lateral movement of said decanter in said reactor.

2. The system of claim 1 wherein said discharge conduit is a substantially rigid, hollow member having at least one hinged section.

3. The system of claim 1 wherein said discharge conduit is a substantially rigid, hollow member having a first hinged section proximate a sidewall of said reactor and a second hinged section proximate said decanter.

4. The system, of claim 1 wherein said discharge conduit is a flexible member.

5. The system of claim 1 wherein the second end of the stabilizing arm is moveably connected to the discharge conduit.

6. The system of claim 1 wherein the second end of the stabilizing arm is fixedly connected to the discharge conduit.

7. The system of claim 1 wherein the second end of the stabilizing arm is moveably connected to the decanter.

8. The system of claim 1 wherein the second end of the stabilizing arm is fixedly connected to the decanter.

9. The system of claim 1 which includes a plurality of stabilizer arms.

10. The system of claim 9 wherein a first stabilizer arm has its second end connected to the decanter, and a second stabilizer arm has its second end connected to the discharge conduit.

11. A decanter mooring system comprising:
a) a decanter having a discharge orifice, said decanter disposed within the reactor containing a liquid, said decanter adapted to move vertically in relation to the surface of said liquid;
b) a discharge conduit connected to said discharge orifice, said discharge conduit having a first hinged section proximate s sidewall of said reactor and a second hinged section proximate said decanter in a manner such that said discharge conduit is in moveable relationship with said decanter; and
c) a stabilizing arm having a first end moveably connected to said reactor and a second end connected to said discharge conduit, in a manner to limit the lateral movement of said decanter in said reactor.

12. The system of claim 11 wherein said second end of said stabilizing arm is moveably connected to said discharge conduit.

13. The system of claim 11 wherein said second end of said stabilizing arm is fixedly connected to said discharge conduit.

14. The system of claim 11 which includes a plurality of stabilizer arms.

15. The system of claim 14 wherein a first stabilizer arm has its second end connected to the decanter, and a second stabilizer arm has its second end connected to the discharge conduit.

16. A method of mooring a decanter in a reactor, the method comprising the steps of:
a) selecting a stabilizing arm, the stabilizing arm having first and second ends;
b) attaching the first end of the stabilizer bar to a reactor sidewall employing a sidewall attachment, and the second end of the stabilizing arm to a component selected from the group consisting of the decanter using a decanter connection, the discharge conduit using a discharge conduit connection, and both the decanter and the discharge conduit.

17. The method of claim 16 wherein the stabilizing arm is connected only to the decanter.

18. The method of claim 16 wherein the stabilizing arm is connected only to the discharge conduit.

19. The method of claim 16 wherein the stabilizing arm comprises first and second stabilizing arms.

20. The method of claim 19 wherein the first stabilizing arm is connected only to the decanter, and the second stabilizing arm is connected only to the discharge conduit.
